(19) United States
(12) Patent Application Publication
(10) Pub. No.: US 2026/0339231 A1
(43) Pub. Date: Oct. 29, 2026

(54) OPTICAL SCANNER WITH HEAT FLOW PASSAGE TO TRANSFER HEAT TO COLLIMATING LENS

(71) Applicant: HEWLETT-PACKARD DEVELOPMENT COMPANY, L.P., Spring, TX (US)

(72) Inventors: Heonhee Lim, Seongnam Si (KR); Jinkwon Chun, Seongnam Si (KR); Geonju Hwang, Seongnam Si (KR)

(73) Assignee: HEWLETT-PACKARD DEVELOPMENT COMPANY, L.P., Spring, TX (US)

(21) Appl. No.: 19/119,745

(22) PCT Filed: Apr. 12, 2023
(86) PCT No.: PCT/US2023/018397

§ 371 Date: Apr. 9, 2025

(30) Foreign Application Priority Data
Oct. 25, 2022 (KR) 10-2022-0138461

(51) Int. Cl. G03G 21/10; G02B 7/00; G03G 15/04

(52) U.S. Cl. CPC G03G 21/10; G02B 7/008; G03G 15/04072; G03G 15/0409; G03G 2215/0404

(57) ABSTRACT

An optical scanner (3) includes a light source (301), a collimating lens (302) to convert light radiated from the light source (301) into collimated light, and a deflector (310) located on a downstream side of the collimating lens (302) to deflect the light in a main scanning direction (X). The optical scanner (3) includes a heat flow passage (33) to transfer heat from the deflector to the collimating lens (302).

### BACKGROUND

Electrophotographic printing devices print an image by developing an electrostatic latent image formed on a photoconductor into a visible toner image, and by transferring and fusing the toner image to a print medium. The print devices employ an optical scanner to irradiate the photoconductor with light modulated in correspondence with image information. The optical scanner deflects the light irradiated from a light source in a main scanning direction by using a deflector. The deflector includes a motor and a deflection mirror coupled to a rotation shaft of the motor. The deflection mirror includes a reflection surface that reflects the light emitted from the light source. As the deflection mirror rotates, an angle between the light and the reflection surface changes, and thus, the light may be scanned in the main scanning direction. The light reflected by the reflection surface forms a spot on the photoconductor by an imaging optical system.

### BRIEF DESCRIPTION OF THE DRAWINGS

FIG. 1 is a schematic view of an example of an optical scanner.

FIG. 2 is a cross-sectional view of an example of the optical scanner shown in FIG. 1, taken along line X1-X1′.

FIG. 3 is a schematic view of an example of the optical scanner.

FIG. 4 is a graph showing a temperature difference between a light source and a collimating lens when a heat flow passage is not present.

FIG. 5 is a graph showing a temperature difference between a light source and a collimating lens when a convection passage is present.

FIG. 6 is a graph showing a variation in focal position and main scanning beam diameter on an object to be exposed, according to an image height on the object to be exposed.

FIG. 7 is a graph showing a variation in focal position and a deviation in main scanning beam diameter on an object to be exposed.

FIG. 8 is a schematic plan view of an example of an optical scanner.

FIG. 9 is a cross-sectional view of an example of the optical scanner shown in FIG. 8, taken along line X2-X2′.

FIG. 10 is a schematic view of an example of an optical scanner.

FIG. 11 is a schematic diagram of an example of a printing device with an optical scanner employed.

### DETAILED DESCRIPTION

An electrophotographic printing device forms an electrostatic latent image to print an image, by scanning light on a photoconductor using an optical scanner, wherein the light is modulated according to an image signal, by developing the electrostatic latent image into a visual toner image, and by transferring and fusing the toner image to a print medium. The optical scanner includes a light source, a deflector to deflect light in a main scanning direction, and an imaging optical system to scan the deflected light at a constant speed on the photoconductor (object to be exposed) to form an image. A collimating lens to convert divergent light from the light source into collimated light is arranged between the light source and the deflector.

An internal temperature of the optical scanner changes during printing due to external factors or heat generated by internal components, and may change by as much as 50 °C depending on the printing speed. Factors that change the temperature of the optical scanner may include a temperature change in an external environment of the printing device, heat of the fuser, heat transfer from print media stacked on a discharge tray of the printing device after output, and the like. In addition, heat generated by components included in the optical scanner, for example, heat generated by a motor driving integrated circuit (IC) that drives a motor of the deflector may also be a factor that increases the temperature of the optical scanner.

Optical properties of collimating lenses are affected by temperature. When the internal temperature of the optical scanner increases, a refractive index and curvature of the collimating lens change, which changes a focal position of an optical system in the optical scanner. Then, a beam diameter on the photoconductor increases, and printing defects, such as bands in a sub-scanning direction, may occur in a printed image. In addition, a temperature of the light source increases rapidly at the beginning of an operation of the optical scanner, and a temperature difference between the light source and the collimating lens also changes a focal position of the optical system. The change in the focal position due to the temperature difference between the light source and the collimating lens may be greater when an optical scanner employs a long focal length optical system, and the quality of a printed image is more affected.

The optical scanner according to the disclosure has a structure to reduce the temperature difference between the light source and the collimating lens. According to some examples, an optical scanner includes a light source, a collimating lens to convert light radiated from the light source into collimated light, a deflector located on a downstream side of the collimating lens to deflect the light in a main scanning direction, and a heat flow passage to transfer heat from the deflector to the collimating lens. The deflector may include a deflection mirror and a motor that rotates the deflection mirror. When the optical scanner is driven, the light source and the motor are driven, and heat is generated from the light source and a motor driving IC for driving the motor. The heat generated from the deflector is transferred to the collimating lens through the heat flow passage. Accordingly, even when a temperature of the light source rapidly increases, the heat is transferred from the deflector to the collimating lens along the heat flow passage, and thus, a temperature of the collimating lens also increases rapidly. Therefore, a temperature difference between the light source and the collimating lens may be reduced, and a change in focal position caused by the temperature difference between the light source and the collimating lens may be reduced.

The heat flow passage may be implemented in various forms to transfer the heat from the deflector to the collimating lens, for example, by convection or conduction. For example, the heat flow passage may be implemented by a convection passage through which heat is transferred from the deflector to the collimating lens by convection. The optical scanner may include an optical frame comprising a lower frame and an upper frame covering an upper portion of the lower frame and forming an accommodation space for accommodating the light source, the collimating lens, and the deflector. The convection passage may be formed by an upper wall of the upper frame partially protruding upward. An optical path between the collimating lens and the deflector is partially separated from an internal space of the optical scanner by ribs or the like such that unnecessary light does not enter the deflector. Accordingly, heat transfer by convection through the optical path may be insufficient to increase the temperature of the collimating lens. The convection passage forms a heat transfer passage between the deflector and the collimating lens by convection, thereby reducing the temperature difference between the light source and the collimating lens. For example, a width of the convection passage may be less on a side of the collimating lens than on a side of the deflector. Accordingly, the heat from the deflector may be intensively transferred to the collimating lens.

For example, the heat flow passage may be implemented by a thermal conductor extending from the deflector toward the collimating lens and transferring heat by conduction. For example, the deflector may include a support plate on which the motor is supported. The thermal conductor may be in contact with both the support plate and the collimating lens, or either one. The heat from the deflector may be directly transferred to the collimating lens by the thermal conductor.

The temperature difference between the light source and the collimating lens may be reduced by dissipating heat generated from the light source. For example, the optical scanner may include a heat sink which is in contact with the light source and dissipates the heat generated from the light source. The heat sink may be arranged outside the optical frame. Accordingly, the heat generated from the light source may be dissipated to the outside of the optical scanner.

For example, the collimating lens may include a diffractive optical element (DOE) collimating lens. The DOE collimating lens may be a lens including a light incident surface on which a diffractive pattern is formed. The diffractive pattern may reduce a variation in focal position when a temperature of the optical scanner is constant.

According to some examples, an optical scanner includes a light source, a collimating lens to convert light radiated from the light source into collimated light, a deflector located on a downstream side of the collimating lens to deflect light in a main scanning direction, and an optical frame to form a space in which the light source, the collimating lens, and the deflector are accommodated, wherein an area of an upper frame of the optical frame between the deflector and the collimating lens partially protrudes upward so that a convection passage through which heat from the deflector is transferred to the collimating lens by convection is formed. The optical scanner may include the thermal conductor described above. The optical scanner may include the heat sink described above.

According to some examples, a printing device includes a photoconductor and the forementioned optical scanner to form an electrostatic latent image by irradiating the photoconductor with light. Examples of an optical scanner and a printing device employing the optical scanner are described below. Members performing the same functions are denoted by the same reference symbols, and redundant descriptions thereof may be omitted.

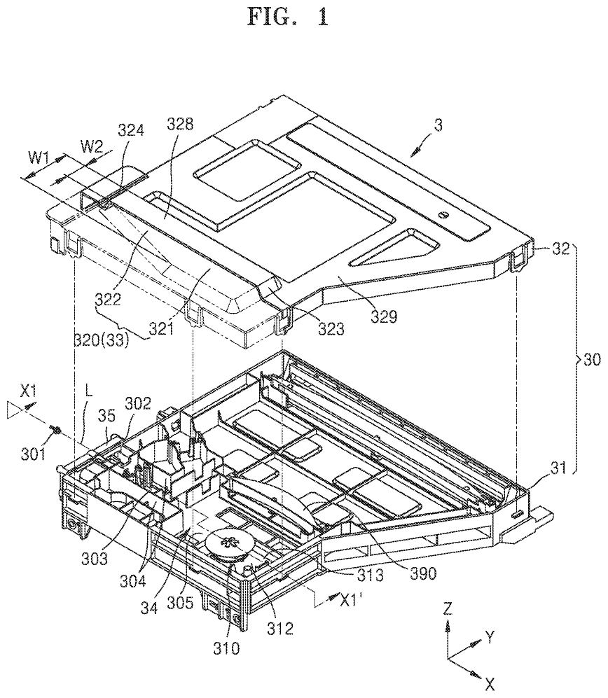

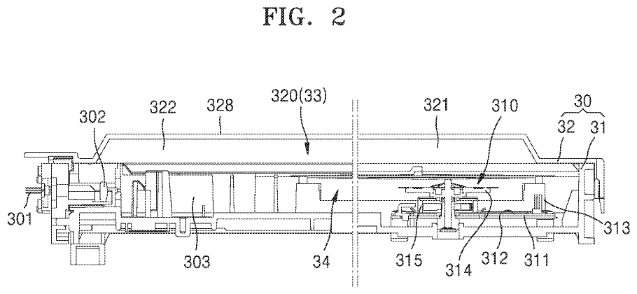

FIG. 1 is a schematic view of an example of an optical scanner 3. FIG. 2 is a cross-sectional view of an example of the optical scanner 3 shown in FIG. 1, taken along line X1-X1′. In FIG. 1, X represents the main scanning direction, Y represents the optical axis direction of the imaging optical system, and Z represents the sub-scanning direction. In FIG. 1, an upper frame 32 is shown. Referring to FIGS. 1 and 2, the optical scanner 3 may include a light source 301, a collimating lens 302 (see FIG. 2) to convert light L radiated from the light source 301 into collimated light, a deflector 310 to deflect, in the main scanning direction X, light on a downstream side of the collimating lens 302 based on a traveling direction of the light L, and a heat flow passage 33 for transferring heat from the deflector 310 to the collimating lens 302.

The optical scanner 3 may include an optical frame 30 forming an accommodation space 34 to accommodate optical elements, for example, the light source 301, the collimating lens 302, the deflector 310, and an imaging optical system 390. The optical frame 30 may include a lower frame 31 and an upper frame 32, the upper frame 32 to cover an upper portion of the lower frame 31 to form the accommodation space 34. The optical elements of the optical scanner 3, for example, the light source 301, the collimating lens 302, the deflector 310, and the imaging optical system 390, may be supported by the lower frame 31. The optical frame 30 may include a support frame 35 coupled to an outer portion of the lower frame 31 in the main scanning direction X. An optical path 303 provides a passage through which the light L passes, and the optical path 303 is provided between the collimating lens 302 and the deflector 310 in the accommodation space 34 of the optical frame 30. The optical path 303 is partially separated from the accommodation space 34 by ribs 304 such that unnecessary light does not enter the deflector 310. In other words, the optical path 303 has openings on a side of the collimating lens 302 and on a side of the deflector 310, and may be formed by a bottom 305 of the lower frame 31, an upper wall 329 of the upper frame 32, and the ribs 304.

For example, the light source 301 may be a laser light source. For example, the light source 301 may be supported by a side portion of the lower frame 31 in the main scanning direction X. In those examples, the light source 301 may be coupled to the support frame 35. The light source 301 may be mounted on a light source driving circuit board (not shown), and the light source driving circuit board may be coupled to the support frame 35. Accordingly, the light source 301 may be accommodated in the accommodation space 34 of the optical frame 30. A cylindrical lens (not shown) may be arranged between the collimating lens 302 and the deflector 310. For example, the cylindrical lens may have refractive power in the sub-scanning direction (Z). The cylindrical lens condenses the light L, that is, collimated light, passing through the collimating lens 302 onto a reflection surface of a deflection mirror 314 of the deflector 310.

The deflector 310 may include the deflection mirror 314 to deflect the light L in the main scanning direction X and a motor 315 to rotate the deflection mirror 314. The deflection mirror 314 includes a reflection surface. The motor 315 includes a stator (not shown) and a rotor (not shown) rotated by electromagnetic interaction with the stator. The deflection mirror 314 is coupled to a rotation shaft of the rotor of the motor 315. The deflector 310 may include a circuit board 312. The circuit board 312 may include a current supply circuit to supply current to the stator, and may include a motor driving IC 313 to drive the motor 315. The motor 315 and the circuit board 312 may be supported by a support plate 311. For example, the rotation shaft of the rotor of the motor 315 may be supported by the support plate 311. The support plate 311 is coupled to the lower frame 31 of the optical frame 30. The support plate 311 may be formed of a metal having high rigidity and high thermal conductivity.

The imaging optical system 390 forms an image of the light L deflected by the deflector 310 on a surface to be scanned of an object to be exposed, that is, an outer circumferential surface of the photoconductor. The optical axis of the imaging optical system 390 extends in the Y direction perpendicular to the main scanning direction X. The imaging optical system 390 may be an f-theta (f-θ) lens that forms an image by scanning the light L at a constant speed on the object to be exposed. The imaging optical system 390 may have an optical shape, the optical shape formed based on for example, a distance between the imaging optical system 390 and the light deflector 310 and a distance between the deflector 310 and the object to be exposed.

The collimating lens 302 may be, for example, a glass lens. For a lower cost, the collimating lens 302 may be a plastic lens. The collimating lens 302 may be a diffractive optical element (DOE) collimating lens. The DOE collimating lens may be a lens including a light incident surface on which a diffractive optical element is provided and light is incident from the light source 301. The diffractive optical element reduces variation in focal position when a temperature of the optical scanner 3 is uniform. The variation in the focal position refers to a variation in focal position in the optical axis direction (Y). Hereinafter, it is assumed that a variation in focal position is “0” when the focus is formed on an object to be exposed, that the focal position moves toward the −Y direction when the focus is formed in front of the object to be exposed, and that the focal position moves toward the +Y direction when the focus is formed behind the object to be exposed. The DOE collimating lens may be a plastic lens. In some examples, the collimating lens 302 may be a DOE collimating lens made of plastic.

When the optical scanner 3 and a printing device including the optical scanner 3 are in operation, the internal temperature of the optical scanner 3 may increase due to heat from the fuser, heat transfer from the print media stacked on a discharge tray of the printing device, heat from the motor driving IC 313 of the deflector 310, or the like. When the internal temperature of the optical scanner 3 increases, a refractive index and a curvature of the collimating lens 302 may change. For example, when the internal temperature of the optical scanner 3 increases, the refractive index and the curvature of the collimating lens 302 may decrease. Then, the focal position by the optical elements of the optical scanner 3 may move toward the +Y direction. When the collimating lens 302 is made of plastic, variations in the refractive index and curvature are relatively greater than when the collimating lens 302 is made of glass. The diffractive optical element of the collimating lens 302 may reduce a change in the focal position due to a change in the refractive index and curvature when the internal temperature of the optical scanner 3 is substantially uniform. The diffractive optical element of the collimating lens may be designed to reduce a variation in the focal position by, for example, considering a change in the wavelength of the light L according to the temperature change of the light source 301 when the temperature of the optical system in the optical scanner 3 including the light source 301 is uniform. For example, when the internal temperature of the optical scanner 3 increases and the focal position by the optical elements of the optical scanner 3 moves toward the +Y direction, the diffractive optical element of the collimating lens may be designed to reduce the amount of change in the focal position in the +Y direction.

However, the temperature of the light source 301 may increase rapidly at the beginning of an operation of the optical scanner 3. Then, due to characteristics of the laser light source 301, a wavelength of emitted light may increase. The diffractive optical element of the collimating lens 302 is affected by the wavelength and the temperature. When the wavelength of light incident on the diffractive optical element of the collimating lens 302 increases, a diffraction effect becomes greater than a refraction effect, so the focal position moves further toward the −Y direction. In terms of the temperature difference between the light source 301 and the collimating lens 302, as the temperature difference increases, the focal position may move further. The temperature difference between the light source 301 and the collimating lens 302 may be reduced to prevent the focal position from moving further.

To prevent the focal position from moving further, the temperature of the collimating lens 302 may be rapidly increased by, for example, transferring heat from the other optical elements in the optical scanner 3 to the collimating lens 302, so that the temperature difference between the light source 301 and the collimating lens 302 may be reduced. Among the optical elements in the optical scanner 3, the temperature of the deflector 310 rapidly increases. Accordingly, heat generated from the deflector 310 may be transferred to the collimating lens 302. In some examples, the optical scanner 3 may include a heat flow passage 33 to transfer the heat from the deflector 310 to the collimating lens 302. The heat flow passage 33 may be implemented in various forms to transfer the heat from the deflector 310 to the collimating lens 302 by, for example, convection and/or conduction.

For example, referring to FIGS. 1 and 2, the heat flow passage 33 may be implemented by a convection passage 320 to transfer heat from the deflector 310 to the collimating lens 302 by convection. The convection passage 320 may extend from the deflector 310 to the collimating lens 302. The convection passage 320 may be formed by the upper wall 329 of the upper frame 32 partially protruding upward. The convection passage 320 may be formed under the protruding portion 328 (protrusion) of the upper wall 329. When the deflector 310 is driven, heat is generated in the motor driving IC 313. This heat increases the temperature of air around the deflector 310, and the high-temperature air flows to the collimating lens 302 along the convection passage 320 to increase the temperature of the collimating lens 302. Accordingly, the temperature difference between the light source 301 and the collimating lens 302 may be reduced. The flow of air generated by rotation of the deflection mirror 314 promotes movement of air through the convection passage 320. Accordingly, heat transfer from the deflector 310 to the collimating lens 302 may be promoted.

A width of the convection passage 320 may be narrower on a side of the collimating lens 302 than on a side of the deflector 310. For example, the convection passage 320 may include a first area 321 above the deflector 310 and a second area 322 extending from the first area 321 toward the collimating lens 302. A width of the second area 322 may be less than a width of the first area 321. In other words, the width W2 of a second end 324 of the convection passage 320 on the side of the collimating lens 302 may be shorter than the width W1 of a first end 323 on the side of the deflector 310. In the examples shown in FIGS. 1 and 2, the width of the second area 322 of the convection passage 320 may gradually decrease from the side of the deflector 310 toward the collimating lens 302. Accordingly, heat from the deflector 310 may be intensively transferred to the collimating lens 302, so that the temperature difference between the light source 301 and the collimating lens 302 may be effectively reduced.

For example, the convection passage 320 may be disposed above the optical path 303 and communicate with the optical path 303. The optical path 303 may be a path for thermal convection between the deflector 310 and the collimating lens 302. Therefore, the optical path 303 and the convection passage 320 may be a heat transfer passage by convection as a whole, and the temperature difference between the light source 301 and the collimating lens 302 may be effectively reduced.

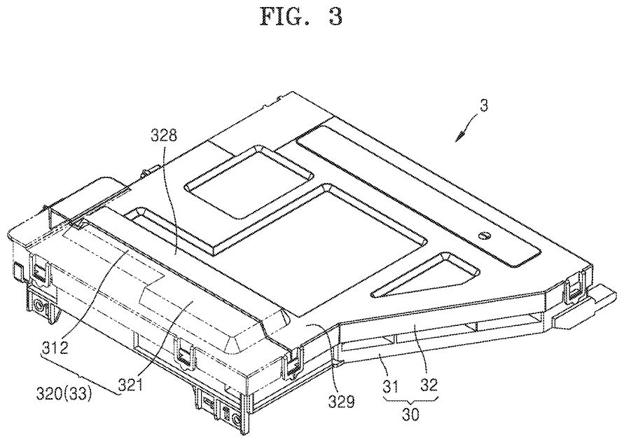

FIG. 3 is a schematic view of an example of the optical scanner 3. FIG. 3 has a convection passage 320 with a different shape compared to the example of the optical scanner 3 shown in FIGS. 1 and 2. In FIG. 3, a partial cross-section of the convection passage 320 is shown. Hereinafter, differences are mainly described. Referring to FIG. 3, the convection passage 320 may include the first area 321 above the deflector 310 and the second area 322 extending from the first area 321 toward the collimating lens 302. The width of the first area 321 is substantially the same. The width of the second area 322 is substantially the same. The width of the second area 322 is shorter than the width of the first area 321. Accordingly, the convection passage 320 is implemented by the first area 321 having a first width and the second area 322 having a second width and being stepped from the first area 321. With this configuration, heat from the deflector 310 may be intensively transferred to the collimating lens 302, so that the temperature difference between the light source 301 and the collimating lens 302 may be reduced.

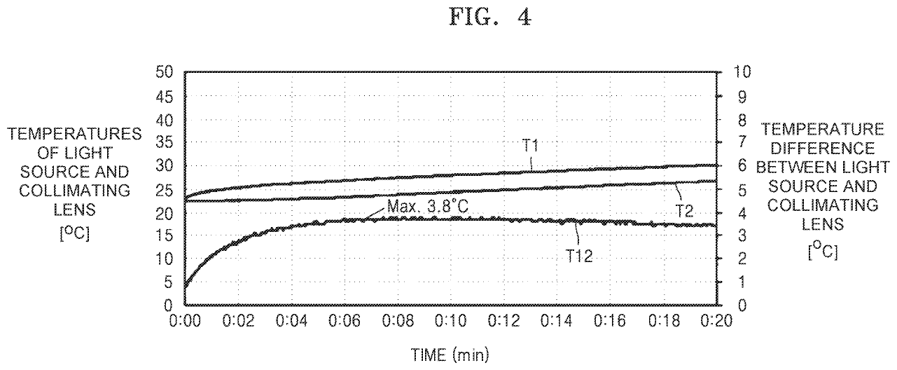

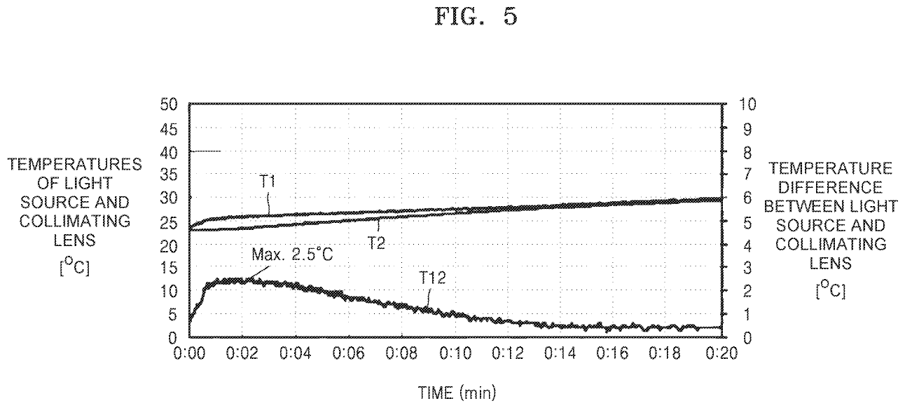

FIG. 4 is a graph showing a temperature difference between the light source 301 and the collimating lens 302 when the heat flow passage 33 is not present. FIG. 5 is a graph showing a temperature difference between the light source 301 and the collimating lens 302 when the convection passage 320 is present. The test conditions are shown below.
Printing device: for A3
Print resolution: 600 dot per inch (dpi)
Printing speed: 31 pages per minute (ppm)
Rotation speed of the motor 315: 25,600 (revolutions per minute) (rpm)
Light source 301: a laser diode with two light-emitting points
Collimating lens 302: a DOE collimating lens
Test method: continuous printing of test pages for 20 minutes at room temperature

In FIGS. 4 and 5, T1 represents a temperature of the light source 301, T2 represents a temperature of the collimating lens 302, and T12 represents a difference between the temperature of the light source 301 and the temperature of the collimating lens 302. Referring to FIG. 4, without a heat flow passage, T12 is up to 3.8 °C. Referring to FIG. 5, with the convection passage 320, T12 is up to 2.5 °C, and the temperature difference is reduced by about 34%.

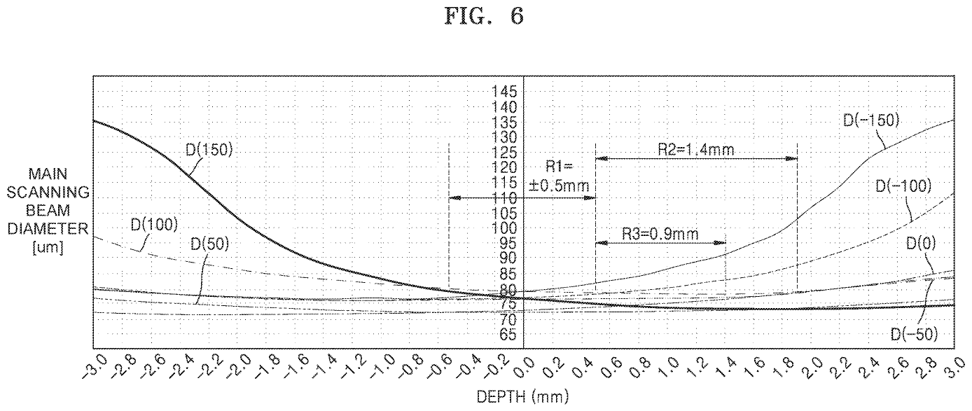

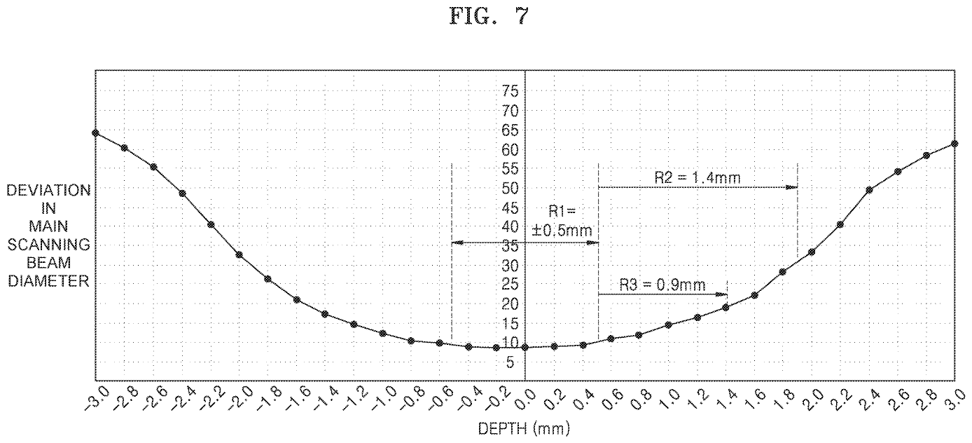

FIG. 6 is a graph showing a variation in focal position and main scanning beam diameter on an object to be exposed, according to an image height (position in the main scanning direction X) on the object to be exposed. FIG. 7 is a graph showing a variation in focal position and a deviation in main scanning beam diameter on an object to be exposed. In FIG. 6, a reference symbol D is shown with a number in parenthesis that indicates an image height on the object to be exposed. For example, D(150) indicates an image height of 150 mm and represents a position 150 mm away from the optical axis of the imaging optical system 390 in the main scanning direction X. In FIGS. 6 and 7, R1 represents a process dispersion of a variation in focal position generated during a manufacturing process of the optical scanner 3, and R1 may be about +0.5 mm. R2 represents a variation in focal position when the heat flow passage 33 is not present. R3 represents a variation in focal position when the convection passage 320 is present.

When the heat flow passage 33 is not present, and the temperature difference T12 between the light source 301 and the collimating lens 302 is about 3.8 °C, R2 is about 1.4 mm, and considering the process dispersion, a maximum value of the variation in focal position is about 1.9 mm. In this case, as shown in FIG. 6, a maximum value of the main scanning beam diameter is about 105 μm, and a deviation in the main scanning beam diameter is about 32 μm. For example, when the main scanning beam diameter is greater than 95 μm or a beam diameter deviation for each position in the main scanning direction X is greater than or equal to 20 μm, a band in the sub-scanning direction may be generated in a printed image, resulting in poor printing quality.

When the convection passage 320 is present, the temperature difference T12 between the light source 301 and the collimating lens 302 is at most 2.5 °C, as shown in FIG. 5. In this case, R2 is about 0.9 mm, and considering the process dispersion, the maximum value of the variation in focal position is about 1.4 mm. In this case, as shown in FIG. 6, the maximum value of the main scanning beam diameter is about 91 μm, and a deviation in the main scanning beam diameter is about 19 μm. Therefore, quality defects in printed images may be reduced or prevented.

The above test results are summarized in Table 1 below.

TABLE 1

| | (A) Without | (B) With | (B) − (A) |
|---|---|---|---|
| | heat flow | convection | Amount of |
| | passage | passage | improvement |
| Variation in focal position | −1.4 | −0.9 | 0.5 |
| (mm) | | | |
| Beam diameter (μm) | 105 | 91 | 14 |
| Deviation in beam diameter | 32 | 19 | 13 |
| for each image height (μm) | | | |

As described above, by employing the convection passage 320 as the heat flow passage 33, a variation in focal position, an amount of increase in the beam diameter, and a deviation in the beam diameter according to the temperature difference between the light source 301 and the collimating lens 302 may be reduced, and the print quality may be improved. In addition, because the deflector 310, which is a heat source, is greater in size than the collimating lens 302, heat transfer efficiency may be increased by making the convection passage 320 narrower on the side of the DOE collimating lens 302 than on the side of the deflector 310. By employing the heat flow passage 33, a plastic collimating lens that is relatively temperature sensitive but inexpensive may be used, and furthermore, a plastic DOE collimating lens that reduces the variation in focal position at a uniform temperature may be used.

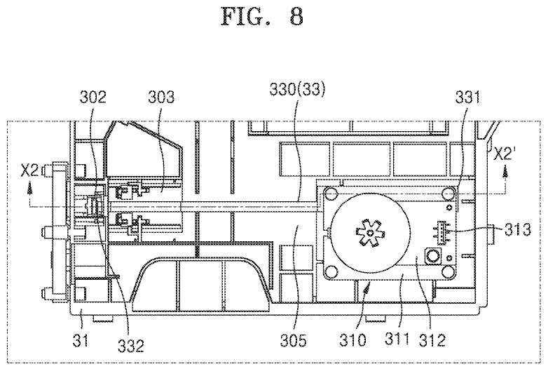

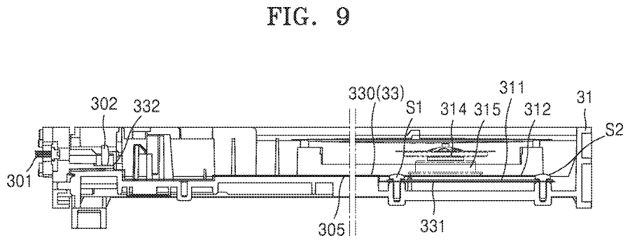

For example, the heat flow passage 33 may have a structure in which heat from the deflector 310 is transferred to the collimating lens 302 by conduction. FIG. 8 is a schematic plan view of an example of the optical scanner 3. FIG. 9 is a cross-sectional view of an example of the optical scanner 3 shown in FIG. 8, taken along line X2-X2′. In FIGS. 8 and 9, the upper frame 32 of the optical frame 30 is omitted. Referring to FIGS. 8 and 9, the heat flow passage 33 may include a thermal conductor 330 extending from the deflector 310 toward the collimating lens 302. The thermal conductivity of the thermal conductor 330 may be greater than the thermal conductivity of the optical frame 30. The thermal conductor 330 may be formed of, for example, a thin copper plate having a high thermal conductivity. The thermal conductor 330 may extend along the optical path 303 from the deflector 310. The thermal conductor 330 may be supported by the lower frame 31, for example, the bottom 305 of the lower frame 31. The thermal conductor 330 may be in contact with at least one of the deflector 310 and the collimating lens 302. When the thermal conductor 330 is not in direct contact with the deflector 310, one end of the thermal conductor 330 may be positioned adjacent to the deflector 310, for example, the support plate 311. When the thermal conductor 330 is not in direct contact with the collimating lens 302, the other end of the thermal conductor 330 may be positioned adjacent to the collimating lens 302.

In some examples, the thermal conductor 330 may be in contact with the deflector 310 and the collimating lens 302. A first end 331 of the thermal conductor 330 may be in contact with the support plate 311 of the deflector 310. For example, the first end 331 of the thermal conductor 330 may be in contact with a lower surface of the support plate 311 and may be coupled to the lower frame 31 together with the support plate 311 by means of screws S1 and S2. Accordingly, a firm contact between the support plate 311 and the first end 331 of the thermal conductor 330 is made. Because the support plate 311 is formed of a metal with a high thermal conductivity and supported in contact with the circuit board 312 on which the motor 315 and the motor driving IC 313 generating a lot of heat are mounted, heat from the deflector 310 may be effectively transferred to the first end 331 of the thermal conductor 330 through the support plate 311. A second end 332 of the thermal conductor 330 may be in contact with the collimating lens 302. For example, the thermal conductor 330 extends below the collimating lens 302 along the optical path 303 from the first end 331, and the collimating lens 302 may be in contact with the second end 332. The second end 332 of the thermal conductor 330 may be in contact with a non-optical area of the collimating lens 302, that is, an area through which the light L does not pass. The second end 332 of the thermal conductor 330 may have various shapes capable of ensuring as much contact area as possible with the non-optical area of the collimating lens 302. For example, the second end 332 of the thermal conductor 330 may have a shape following the contour of the non-optical area of the collimating lens 302. Accordingly, heat from the deflector 310 may be transferred to the collimating lens 302 by conduction through the thermal conductor 330.

Although not shown in FIGS. 8 and 9, the convection passage 320 described with reference to FIGS. 1 to 3 may be applied to the examples of the optical scanner 3 shown in FIGS. 8 and 9. As a number of light-emitting points in the light source 301 increases, an increase in temperature of the light source 301 and increase in the wavelength of light may increase when the light source 301 is driven. By employing the thermal conductor 330 together with the convection passage 320, the temperature difference between the light source 301 and the collimating lens 302 may be further reduced.

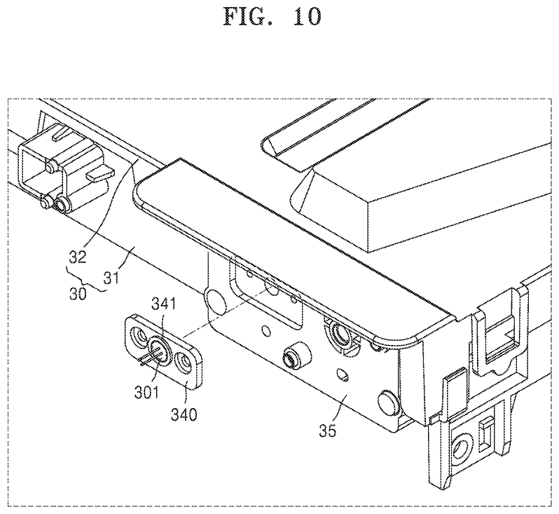

As an example method of reducing the temperature difference between the light source 301 and the collimating lens 302, heat generated from the light source 301 may be dissipated to the outside of the optical scanner 3. FIG. 10 is a schematic view of an example of the optical scanner 3. Referring to FIG. 10, the optical scanner 3 may include a heat sink 340 that is in contact with the light source 301, the heat sink dissipating heat generated from the light source 301. The heat sink 340 may be formed of a metal with a high thermal conductivity. For example, the heat sink 340 may include a hole 341 into which the light source 301 is inserted. When the light source 301 is inserted into the hole 341, an outer surface of the light source 301 comes into contact with the heat sink 340, and the heat generated from the light source 301 is transferred to the heat sink 340. The heat sink 340 is located outside the optical frame 30. For example, the heat sink 340 may be supported by the support frame 35 coupled to an outer portion of the lower frame 31 in the main scanning direction X. Accordingly, the heat generated in the light source 301 may be dissipated to the outside, thereby preventing the temperature rise in the light source 301.

Although not shown in the drawings, the convection passage 320 described with reference to FIGS. 1 to 3 may be applied to the example of the optical scanner 3 shown in FIG. 10. In addition, the thermal conductor 330 described with reference to FIGS. 8 and 9 may be applied to the example of the optical scanner 3 shown in FIG. 10. In addition, the convection passage 320 described with reference to FIGS. 1 to 3 and the thermal conductor 330 described with reference to FIGS. 8 and 9 may be applied to the example of the optical scanner 3 shown in FIG. 10. Accordingly, the temperature difference between the light source 301 and the collimating lens 302 may be further reduced.

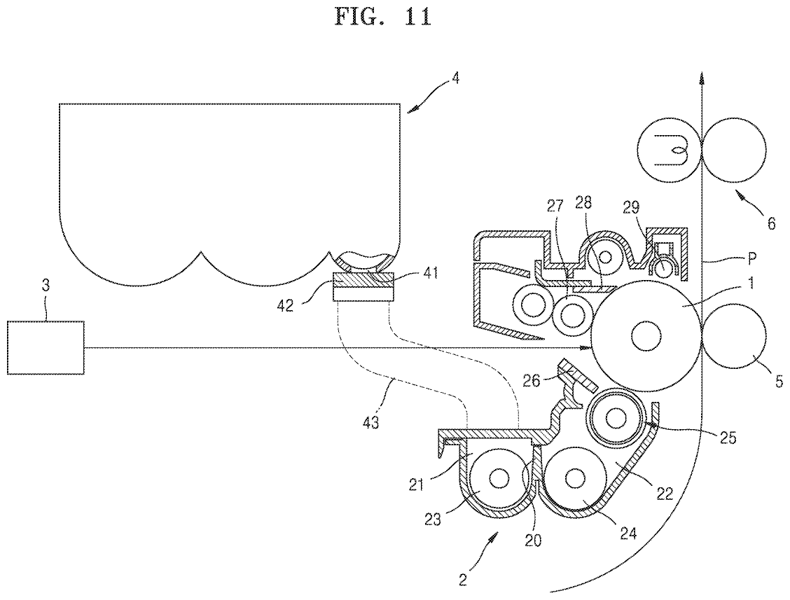

FIG. 11 is a schematic diagram of an example of a printing device with the optical scanner 3 employed. The printing device according to some examples is a single color printing device with a two-component developer including a toner and a magnetic carrier. A color of the toner may be, for example, black. Referring to FIG. 11, the printing device may include the photoconductive drum 1, and the optical scanner 3 that forms an electrostatic latent image by irradiating the photoconductive drum 1 with light.

The photoconductive drum 1 is an example of a photoconductor in which an electrostatic latent image is formed. The charging roller 27 is an example of a charger that charges a surface of the photoconductive drum 1 with a uniform surface electric potential. The charging roller 27 is rotated in contact with the photoconductive drum 1, and a charging bias voltage is applied to the charging roller 27. A cleaning blade 28 removes, for example, residual toner on the surface of the photoconductive drum 1 after a transfer process as described later. A static eliminator 29 may be disposed on an upstream side of the cleaning blade 28 based on a rotational direction of the photoconductive drum 1 to remove residual potential on the photoconductive drum 1. For example, the static eliminator 29 may irradiate a surface of the photoconductive drum 1 with light. The optical scanner 3 forms an electrostatic latent image by irradiating the surface of the charged photoconductive drum 1 with light corresponding to image information. The optical scanner 3 described with reference to FIGS. 1 to 3 and FIGS. 8 to 10 may be employed as the optical scanner 3.

A developing device 2 may be a developing device including the photoconductive drum 1 and a developing roller 25. A developer is accommodated in the developing device 2. The developer is transferred along a path inside the developing device 2, and in this process, the toner and the carrier are agitated together. The developing device 2 may include an agitation chamber 21 and a developing chamber 22. The developing roller 25 is installed in the developing chamber 22. The developing roller 25 is partially exposed to the outside of the developing chamber 22, and the exposed portion of the developing roller 25 faces the photoconductive drum 1. The agitation chamber 21 is separated from the developing chamber 22 by a partition wall 20. First and second communicating portions (not shown) are provided at opposite ends of the partition wall 20 in the longitudinal direction, respectively, to communicate the agitation chamber 21 and the developing chamber 22. First and second conveying members 23 and 24 are installed in the agitation chamber 21 and the developing chamber 22, respectively, to convey and circulate the developer inside the agitation chamber 21 and the developing chamber 22 along a path formed by the agitation chamber 21-first communicating portion-developing chamber 22-second communicating portion-agitation chamber 21. A portion of the developer conveyed in the developing chamber 22 adheres to the developing roller 25. Toner inside the developing chamber 22 is adhered to a carrier by an electrostatic force, and the carrier is adhered to a surface of the developing roller 25 by a magnetic force of the developing roller 25. Accordingly, a developer layer is formed on the surface of the developing roller 25. The developing roller 25 partially faces the photoconductive drum 1. A thickness of the developer adhered to the surface of the developing roller 25 is regulated by the regulating member 26, and is conveyed to a developing area where the photoconductive drum 1 and the developing roller 25 face each other. The toner is transferred from the developer layer on the developing roller 25 to the photoconductive drum 1 according to a developing bias voltage applied between the developing roller 25 and the photoconductive drum 1, and a visible toner image is formed on the surface of the photoconductive drum 1.

The transfer roller 5 is an example of a transfer unit that transfers the toner image formed on the photoconductive drum 1 to a print medium P. The transfer roller 5 faces the photoconductive drum 1 and forms a transfer nip. A transfer bias voltage is applied to the transfer roller 5, and a transfer electric field is formed between the photoconductive drum 1 and the transfer roller 5. The toner image developed on the surface of the photoconductive drum 1 is transferred to the print medium P by the transfer electric field. The toner image transferred to the print medium P is adhered to the print medium P by an electrostatic force. A fuser 6 fuses the toner image to the print medium P by applying heat and pressure.

When the toner inside the developing device 2 is consumed, the developer may be supplied from a developer container 4 to the developing device 2. A discharge port 41 is provided in the developer container 4. The developer container 4 may include a shutter 42 for selectively opening and closing the discharge port 41. The discharge port 41 and the developing device 2 may be connected by a developer supply member 43. With this configuration, the developer may be supplied from the developer container 4 to the developing device 2.

It should be understood that aspects, advantages, and features described herein are not necessarily achieved or included in any one particular example, and that examples described herein should be considered in a descriptive manner. Indeed, while various examples have been described and shown herein, it should be apparent that other examples may be possible in terms of, for example, arrangement, substitution, combination, and/or configuration. All corrections and modifications included in the scope of the subject matter disclosed herein are claimed. Descriptions of features or aspects within each example should be considered as available for other similar features or aspects in other examples. While some examples are described with reference to the drawings, it should be noted that those of ordinary skill in the art would consider various changes in form and details within the scope of the disclosure.

1. An optical scanner comprising:
a light source;
a collimating lens to convert light radiated from the light source into collimated light;
a deflector located on a downstream side of the collimating lens, the deflector comprising a deflection mirror to deflect the collimated light in a main scanning direction and a motor to rotate the deflection mirror; and
a heat flow passage to transfer heat from the deflector to the collimating lens.

2. The optical scanner of claim 1, comprising an optical frame to form an accommodation space to accommodate the light source, the collimating lens, and the deflector,
wherein the optical frame comprises a lower frame and an upper frame, the upper frame covering an upper portion of the lower frame, and
wherein the heat flow passage comprises a passage to transfer heat from the deflector to the collimating lens.

3. The optical scanner of claim 2, wherein the passage is wider on a side of the deflector than on a side of the collimating lens.

4. The optical scanner of claim 2, wherein the passage is located above an optical path between the collimating lens and the deflector.

5. The optical scanner of claim 1, wherein the heat flow passage comprises a thermal conductor extending from the deflector toward the collimating lens.

6. The optical scanner of claim 5, wherein:
the deflector comprises a support plate to support the motor; and
the thermal conductor is in contact with at least one of the support plate and the collimating lens.

7. The optical scanner of claim 1, comprising a heat sink connected to the light source, the heat sink to dissipate heat from the light source.

8. The optical scanner of claim 7, comprising an optical frame to form an accommodation space to accommodate the light source, the collimating lens, and the deflector,
wherein the optical frame comprises a lower frame and an upper frame, the upper frame covering an upper portion of the lower frame, and
wherein the heat sink is located outside the optical frame.

9. The optical scanner of claim 1, wherein the collimating lens comprises a diffractive optical element (DOE) collimating lens.

10. An optical scanner comprising:
a light source;
a collimating lens to convert light radiated from the light source into collimated light;
a deflector located on a downstream side of the collimating lens to deflect the collimated light in a main scanning direction; and
an optical frame to form a space to accommodate the light source, the collimating lens, and the deflector,
wherein an area in an upper frame of the optical frame between the deflector and the collimating lens partially protrudes upward to form a passage through which heat from the deflector is transferred to the collimating lens.

11. The optical scanner of claim 10, wherein:
the deflector comprises:
a deflection mirror to deflect light;
a motor to rotate the deflection mirror; and
a support plate to support the motor; and
the optical scanner comprises a thermal conductor, the thermal conductor including one end, the one end connected to the support plate and extending toward the collimating lens to transfer the heat from the deflector to the collimating lens.

12. The optical scanner of claim 10, comprising a heat sink connected to the light source and located outside the optical frame, the heat sink to dissipate heat generated from the light source.

13. A printing device comprising:
a photoconductor; and
an optical scanner to form an electrostatic latent image by irradiating the photoconductor with light, the optical scanner comprising:
a light source;
a collimating lens to convert light radiated from the light source into collimated light;
a deflector located on a downstream side of the collimating lens, the deflector comprising:
a deflection mirror to deflect the collimated light in a main scanning direction; and
a motor to rotate the deflection mirror; and
an optical frame to form a space to accommodate the light source, the collimating lens, and the deflector,
wherein an area in an upper frame of the optical frame between the deflector and the collimating lens partially protrudes upward to form a passage through which heat from the deflector is transferred to the collimating lens.

14. The printing device of claim 13, comprising a thermal conductor extending from the deflector toward the collimating lens to transfer the heat from the deflector to the collimating lens.

15. The printing device of claim 13, comprising a heat sink connected to the light source and located outside the optical frame, the heat sink to dissipate heat generated from the light source.
